(19) United States
(12) Patent Application Publication
(10) Pub. No.: US 2024/0157320 A1
(43) Pub. Date: May 16, 2024

(54) Moving Bed Lipid Conversion With Fluid Bed Catalyst Regeneration

(71) Applicant: Chevron U.S.A. Inc., San Ramon, CA (US)

(72) Inventors: Steven Xuqi Song, El Cerrito, CA (US); Sven Ivar Hommeltoft, Pleasant Hill, CA (US)

(21) Appl. No.: 18/054,293

(22) Filed: Nov. 10, 2022

(51) Int. Cl. B01J 8/26; B01J 8/00; B01J 29/90

(52) U.S. Cl. CPC B01J 8/26; B01J 8/0055; B01J 29/90

(57) ABSTRACT

A reactor system includes a moving bed reactor that treats a lipid feedstock using a metal oxide catalyst to produce a treated stream comprising a bio-oil. The reactor system further includes a fluidized bed regenerator that regenerates spent metal oxide catalyst from the treating process in the moving bed reactor. Once the spent metal oxide catalyst is regenerated into metal oxide catalyst, it is returned to the moving bed reactor. The metal oxide catalyst returned to the moving bed reactor can contribute heat to the lipid feedstock to raise the lipid feedstock to a reaction temperature.

### TECHNICAL FIELD

Embodiments of the technology relate generally to upgrading compositions that may be used as renewable feedstocks for refinery processing and regeneration of catalysts used in such upgrading.

### BACKGROUND

There is an increasing interest in alternative feedstocks for replacing at least partly crude oil, in the production of hydrocarbons, suitable as fuels or fuel components, for example as transportation fuels, or compatible with fuels. Biofuels are typically manufactured from feedstock originating from renewable sources including oils and fats obtained from plants, animals, algal materials, fish, and various waste streams, side streams and sewage sludge. These feedstocks, particularly the various waste streams and side streams, contain varying amounts of contaminants, such as gums, organic chlorine compounds, phospholipids and other phosphorus compounds, metals and metal compounds, and residual soaps, which are, for example, deleterious to converting catalysts.

Despite the ongoing research and development in the processing of renewable feedstocks and manufacture of fuels, there is still a need to provide an improved process for purifying renewable feedstock to provide purified feedstock, which is suitable for converting to valuable chemicals, such as hydrocarbons suitable as fuels or fuel blending components. In particular, there is a need for reactor systems that can efficiently process such alternative and renewable feedstocks.

### SUMMARY

In one example embodiment, the present disclosure is generally directed to a process for treating a lipid feedstock. The process can comprise: a) treating a lipid feedstock comprising at least one fatty acid in a moving bed reactor with a metal oxide catalyst on an oxide support under treating conditions to produce a treated stream, wherein the treating conditions in the moving bed reactor include a temperature in a range of from 400° C. to 700° C., a pressure in a range from 0 to 10 MPa, and a liquid hourly space velocity in a range from 0.1 to 10 h⁻¹; b) directing spent metal oxide catalyst from the moving bed reactor to a fluidized bed regenerator, the spent metal oxide catalyst resulting from treating the lipid feedstock with the metal oxide catalyst; c) regenerating the spent metal oxide catalyst in the fluidized bed regenerator by removing coke from the spent metal oxide catalyst in a combustion process that regenerates the spent metal oxide catalyst into the metal oxide catalyst; and d) returning to the moving bed reactor the metal oxide catalyst that has been regenerated in the fluidized bed regenerator.

In another example embodiment, the present disclosure is generally directed to a reactor system for treating a lipid feedstock. The reactor system can comprise: a) a lipid feedstock inlet that directs a lipid feedstock into the reactor system; b) a moving bed reactor comprising metal oxide catalyst, a metal oxide catalyst inlet, a treated stream outlet, and a spent catalyst outlet; c) a fluidize bed regenerator comprising an air inlet, a riser, and a flue gas outlet; d) a bottom conduit connecting the spent catalyst outlet to the fluidized bed regenerator; and e) a top conduit connecting the metal oxide catalyst inlet to the riser.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a reactor system and a method for processing a lipid feedstock and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates components of a reactor system in accordance with an example embodiment of the disclosure.

FIG. 2 illustrates a method for processing a lipid feedstock in accordance with an example embodiment of the disclosure.

### DETAILED DESCRIPTION OF EXAMPLE EMBODIMENTS

The example embodiments discussed herein are directed to apparatus and methods for processing a lipid feedstock. The example apparatus and methods described herein are particularly beneficial in the oil and gas industry where lipid feedstocks can be used in the production of hydrocarbon fluids. As will be described further below, the apparatus and methods described herein utilize a reactor system comprising a moving bed reactor and a fluidized bed regenerator for treating lipid feedstocks to produce a bio-oil renewable feedstock suitable for refinery operations.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

### Definitions

The term “lipid” is known in the art and refers to fatty acids and their derivatives. Accordingly, examples of lipids include fatty acids (both saturated and unsaturated); glycerides or glycerolipids, also referred to as acylglycerols (such as monoglycerides (monoacylgycerols), diglycerides (diacylglycerols), triglycerides (triacylglycerols, TAGs, or neutral fats); phosphoglycerides (glycerophospholipids); nonglycerides (sphingolipids, sterol lipids, including cholesterol and steroid hormones, prenol lipids including terpenoids, fatty alcohols, waxes, and polyketides); and complex lipid derivatives (sugar-linked lipids or glycolipids, and protein-linked lipids).

The term “fatty acid” refers to a monocarboxylic acid having an aliphatic chain containing 3 to 39 carbon atoms, more particularly 7 to 23 carbon atoms. The aliphatic chain may be linear or branched and may be saturated or unsaturated (e.g., contain one or more carbon-carbon double bonds).

The term “bio-oil” means a liquid product produced from biomass by a thermochemical process. Bio-oil may include bio-derived hydrocarbon fractions and oxygenated hydrocarbons such as carboxylic acids, alcohols, aldehydes, ketones, etc.

The term “pyrolysis” refers to the thermal decomposition of organic materials in an oxygen-lean atmosphere (i.e., significantly less oxygen than required for complete combustion).

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, but is not limited to, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “transportation fuels” refer here to fractions or cuts or blends of hydrocarbons having distillation curves standardized for fuels, such as for diesel fuel (middle distillate from 160° C. to 380° C., according to EN 590), gasoline (40° C. to 210° C., according to EN 228), aviation fuel (160° C. to 300° C., according to ASTM D-1655 jet fuel), kerosene, naphtha, etc. Liquid fuels are hydrocarbons having distillation curves standardized for fuels, such as transportation fuels.

The term “ppm” means parts-per-million and is a weight relative parameter. A part-per-million is a microgram per gram, such that a component that is present at 10 ppm is present at 10 micrograms of the specific component per 1 gram of the aggregate mixture.

### Lipid Feedstock

The lipid feedstocks described herein originate from a renewable or biological source or sources, and the lipid feedstocks are meant to include here feedstocks other than those obtained from mineral oil, shale oil, or coal.

The lipid feedstock may for example comprise 0 to 90 wt. % of free fatty acids, 5 to 100 wt. % fatty acid glycerol esters (e.g., mono-, di-, triglycerides) and 0 to 20 wt. % of one or more compounds selected from the list consisting of: fatty acid esters of the non-glycerol type, fatty amides, and fatty alcohols, where the renewable feedstock comprises more than 50 wt. % of free fatty acids and fatty acid glycerol esters such as 70 wt. % or more, for example 80 wt. % or more.

The lipid feedstock may originate for example from plants, animals, algae (algae oil, algae biomass, algae cultivation), fish and microbiological processes.

Examples of such feedstocks include feedstocks originating from low value renewable waste materials, side streams, by-products, refining waste and residues, sewage sludge, and any combinations thereof.

The lipid feedstock may be selected from the group consisting of acidulated soap-stocks, fatty acid distillates from physical refining of plant oils or animal fats, distillers corn oil (DCO) from ethanol production, waste cooking oils, lard, brown grease, yellow grease, trap grease, waste fats, low-grade oils, supercritical water liquefaction oils (SCWL oils), plant oils, animal fats and any combination thereof.

Such lipid feedstocks typically contain varying amounts of impurities, such as phosphorus, silicon, chloride, alkali metals, earth alkaline metals, other metals, etc.

The lipid feedstock may comprise at least 10 ppm (e.g., 10 to 100 ppm, 10 to 75 ppm, 10 to 50 ppm, 15 to 100 ppm, or 15 to 50 ppm) of chlorine, calculated as elemental chlorine (a Cl atom). Chlorine content can be determined using combustion ion chromatography (ClC). Combustion ion chromatography is a technique in which a sample is burned in oxygen-containing gas flow, the gas generated is absorbed in an adsorption solution and then, a halogen ion adsorbed in the adsorption solution is quantitatively analyzed by an ion chromatography method. The technique makes it possible to easily analyze a halogen component in ppm range which has been conventionally difficult.

Lipid feedstocks comprising one or more of alkali metals, alkaline earth metals, and/or other metals, such as iron and manganese, even in low amounts are often regarded as not suitable for catalytic treatment in refinery operations because each of the metals is an effective catalyst poison. The alkali metals, alkaline earth metals and other metals may typically comprise Na, K, Mg, Ca, Mn, Fe, or a combination thereof.

The lipid feedstock may comprise at least 1 ppm (e.g., 1 to 250 ppm, 1 to 100 ppm, 1 to 50 ppm, 1 to 25 ppm, 2 to 250 ppm, 2 to 100 ppm, or 2 to 25 ppm) of alkali metals, alkaline earth metals, metals of Groups VIIB and VIIIB, or combinations thereof, calculated as elemental metals, in total. Total metals content can be determined using AOCS Recommended Practice Ca 17-01.

Low value lipid feedstocks, such as various types of animal fats and waste oils, generally have a relatively high concentration of free fatty acids. One method of assessing the concentration of free fatty acids is to determine the total acid number (TAN) of the feedstock. The total acid number is the mass of potassium hydroxide (KOH) in milligrams that is required to neutralize one gram of the chemical substance being assessed.

The lipid feedstock may have an acid number of at least 5 mg KOH/g (e.g., 5 to 150 mg KOH/g, 10 to 150 mg KOH/g, 10 to 100 mg KOH/g, 10 to 50 mg KOH/g, from 10 to 25 mg KOH/g, or 10 to 20 mg KOH/g). Acid number can be determined using ASTM D664.

The lipid feedstock may be pretreated. Such pretreatments include, but are not limited to, degumming, neutralization, bleaching, deodorizing, or any combination thereof.

### Treatment of the Lipid Feedstock

In order to provide renewable feedstocks suitable for refinery operations, the lipid feedstock is treated with a metal oxide catalyst on an oxide support under treating conditions to produce a treated stream comprising a liquid fraction comprising a bio-oil which has a lower content of free fatty acids and impurities as compared to the renewable feedstock. The obtained bio-oil is particularly suitable as a renewable feedstock for hydroprocessing in biofuel manufacture.

Without being bound by theory, the treating is believed to proceed by a thermochemical process which includes one of more of cracking, decarboxylation, decarboxylation-coupling, dehydration and/or deoxygenation reactions.

Suitable treating conditions may comprise one or more of the following: a temperature in a range of from 400° C. to 700° C. (e.g., 425° C. to 650° C., or 450° C. to 600° C.); a pressure in a range of from 0 to 10 MPa (e.g., 0.1 to 5 MPa, or 0.1 to 1 MPa); and a liquid hourly space velocity (LHSV) in a range of from 0.1 to 10 h⁻¹ (e.g., 0.2 to 5 h⁻¹, or 0.3 to 3 h⁻¹).

The reaction may be carried out in the presence of a carrier gas such as hydrogen, nitrogen, carbon dioxide, H₂O (water vapor) or C1-C4 hydrocarbons (e.g., methane, ethane, propane or mixtures thereof), preferably, CO₂ or H₂O. These gases may be admixed into the reaction mixture and/or may be formed in the course of the reaction. The carrier gas may be used to expel gaseous or volatile reaction products from the product mixture such as H₂O or CO₂.

The reaction is carried out in the presence of a metal oxide catalyst on an oxide support. The metal of the metal oxide may be selected from Na, K, Mg, Ca, Sr, Cr, Mo, Mn, Fe, Co, Ni, Cu, Zn, Al, rare earth metals, or a mixture thereof. The oxide support may be selected from alumina, silica, silica-alumina, titania, zirconia, or a mixture thereof. In some aspects, the metal oxide catalyst comprises CaO, the oxide support being alumina.

The treating may be conducted in any suitable reactor or reactor configuration, such as a fixed bed reactor, a moving bed, a slurry reactor, a fluidized bed reactor, an ebullating bed reactor, a transport bed reactor, a two-phase bed reactor, a riser reactor, and a batch reactor. The feed stream can be flowed over the catalyst bed either up-flow or down-flow in the liquid, vapor, or mixed phase.

The process may be batch-type or semi-batch-type or continuous, suitably a continuous process is used.

The bio-oil has a lower content of oxygen and impurities as compared to the lipid feedstock.

The bio-oil may have a TAN of less than 5 mg KOH/g (e.g., less than 4 mg KOH/g, less than 3 mg KOH/g, less than 2 mg KOH/g, or less than 1 mg KOH/g).

The bio-oil may comprise less than 10 ppm (e.g., less than 5 ppm, less than 1 ppm, or less than 0.5 ppm) of chlorine, calculated as elemental chlorine (a Cl atom).

The bio-oil may comprise less than 1 ppm of alkali metals, alkaline earth metals, metals of the Groups VIIB and VIIIB of the Periodic Table of Elements (other metals), or combinations thereof, calculated as elemental metals, in total, preferably less than 0.5 ppm.

The oxygen content of the bio-oil may be 5 wt. % or less (e.g., 3 wt. % or less, or 2 wt. % or less), on a dry basis, based on the total weight of the bio-oil. Oxygen content can be determined using ASTM D5291. Lipid feedstocks can have an oxygen content in a range of about 10 to 15 wt. %, on a dry basis, based on the total weight of the feedstock.

### Hydroprocessing

Beneficially, the bio-oil produced by the process disclosed herein may be used directly as a refinery feedstock.

The obtained bio-oil may be blended with one or more mineral oil feedstocks originating from crude oil, shale oil or coal and likewise used as a refinery feedstock.

If desired, the bio-oil may be subjected to a catalytic hydroprocessing step. The obtained at least one effluent (hydroprocessing product) may be fractionated in a fractionating step to provide hydrocarbon fractions, suitable as renewable fuels or fuel components, useful as transportation fuels, fuel components and other chemicals.

The catalytic hydroprocessing step may be carried out in one step or in more than one steps.

The catalytic hydroprocessing step may be carried out by processing one or more fractions (such as distillation cuts) of the bio-oil separately or the bio-oil may be processed as a whole.

The catalytic hydroprocessing may comprise at least a hydrodeoxygenation step. Catalytic hydroprocessing may comprise a hydrodeoxygenation step followed by one or more steps selected from hydroisomerization and hydrocracking steps.

Hydroprocessing may be performed using one or more hydroprocessing catalysts comprising one or more metals selected from Group VIA and Group VIII metals. Particularly useful examples are Mo, W, Co, Ni, Pt and Pd. The catalyst(s) can also contain one or more support materials, for example zeolite, alumina, alumina-silica, zirconia, alumina-silica-zeolite and activated carbon. Suitably a mixture of CoO and MoO₃ (CoMo) and/or a mixture of NiO and MoO₃ (NiMo), and/or a mixture of Ni, Mo and Co and/or NiW and one or more support materials selected from zeolite, alumina, silica, zeolite-alumina, alumina-silica, alumina-silica-zeolite and activated carbon. Also, noble metals, such as Pt and/or Pd dispersed on alumina may be used.

Hydroprocessing conditions can include a temperature of from 100° C. to 450° C. (e.g., 200° C. to 370° C., or 230° C. to 350° C.); a pressure of from 0.5 to 30 MPa (e.g., 3 to 25 MPa, or 3 to 12 MPa); a liquid hourly space velocity of from 0.01 to 10 h⁻¹ (e.g., 0.1 to 5 h⁻¹). The hydrogen gas treat rate can be in a range of from 600 to 4000 Nm3/m3 (e.g., 1300 to 2200 Nm³/m³).

The hydroprocessing occurs in a reaction stage. The reaction stage can comprise one or more reactors or reaction zones each of which comprises one or more catalyst beds of the same or different catalyst. Although other types of catalyst beds/reactors can be used, fixed beds are preferred. Such other types of catalyst beds include fluidized beds, ebullating beds, slurry beds, and moving beds. Interstage cooling or heating between reactors, reaction zones, or between catalyst beds in the same reactor, can be employed.

At least one effluent from the hydroprocessing is drawn off from the last reactor. In one embodiment, the effluent is directed to a separator, such as any suitable separator or flashing unit. In the separator, typically water, gaseous stream comprising hydrogen, light hydrocarbons (e.g., C1-C5 hydrocarbons), H₂S, CO and CO₂ are separated from the liquid component comprising >C5 hydrocarbons and some C1-C5 hydrocarbons. Water and gases may also be separated by other means which are well known to those skilled in the art.

The liquid hydrocarbon stream obtained from the hydroprocessing step includes fuel grade hydrocarbons having a boiling point of at most 380° C., according to ISO EN 3405. The person skilled in the art is able to vary the distilling conditions and to change the temperature cut point as desired to obtain any suitable hydrocarbon product, boiling suitably in the transportation fuel ranges.

### EXAMPLES

The following illustrative examples are intended to be non-limiting.

### Example

For the experimental work, a pretreated used cooking oil (UCO) was used as a feed. Though pretreated by conventional lipid pretreatment methods, the feed still contained impurities (see Table 1 below). In particular, the high chloride and residual metals content along with the high total acid number (TAN) of the pretreated UCO are indicative of the challenges that conventional lipid pretreatment have in removing these impurities to a level that makes lipid feedstocks processable in conventional crude oil refining processes.

The UCO was processed in a continuously operated fixed bed bench scale unit over 50 mL of calcium promoted alumina catalyst at atmospheric pressure and at a temperature of 900° F. or 950° F. In one run, the UCO was processed at a reaction temperature of 900° F. without the addition of water. In the second run, 22 g/h of water was co-fed with the UCO to the reactor operating at 950° F. The chemical and physical properties of the feed and liquid products are summarized in Table 1. Simulated distillation (SIMDIS) was determined according to ASTM D2887.

Chloride content is reported in ppm chlorine by weight of the composition and is determined by combustion ion chromatography. A known weight of sample is placed into a quartz sample boat and introduced into a high temperature combustion tube. The sample is combusted (1050° C.) in an oxygen-rich pyrohydrolytic environment and captures the combustion products in dilute hydrogen peroxide (absorbing solution). The resulting solution is analyzed by Ion Chromatography (IC). Chloride ion is separated from other anions after passing through the analytical column. The conductivity of the eluent is reduced with a suppressor prior to the conductivity detector, where the anion of interest (Cl—) is measured. A set of chloride calibration standards containing known mass of chloride is used to quantify the chloride in the original combusted sample. Samples containing 1 to 100 ppm can be analyzed using this method. Combustion ion chromatography was carried out on a Metrohm Combustion IC to determine the chlorine content.

TABLE 1
Ketopyrolysis of UCO Over Calcium Promoted Alumina

| | | |
|---|---|---|
| UCO Feed | Run 1 | Run 2 |

Conditions

| | | | |
|---|---|---|---|
| Temperature, ° F. | — | 900 | 950 |
| Pressure, atm | — | 1 | 1 |
| Flow, g/h | — | 38 | 39 |
| LHSV, h⁻¹ | — | 0.82 | 0.85 |
| Water flow, g/h | — | — | 22 |

Properties

| | | | |
|---|---|---|---|
| TAN, mg KOH/g | 20 | 0.95 | 1.03 |
| C, wt. % | 77.06 | 85.61 | 85.9 |
| H, wt. % | 11.3 | 12.44 | 12.21 |
| N, wt. % | <1 | <1 | <1 |
| O, wt. % | 11.64 | 1.95 | 1.89 |
| Cl, ppm | 16 | <1 | <1 |
| Na, ppm | 2.04 | <0.21 | <0.28 |
| Ca, ppm | 0.22 | <0.11 | <0.11 |
| Si, ppm | 0.72 | <0.21 | <0.21 |

SIMDIS, ° F.

| | | | | |
|---|---|---|---|---|
| 0.5 | wt. % | 644 | 83 | 298 |
| 5 | wt. % | 686 | 178 | 302 |
| 10 | wt. % | 778 | 230 | 308 |
| 30 | wt. % | 1107 | 371 | 355 |
| 50 | wt. % | 1123 | 483 | 436 |
| 70 | wt. % | 1129 | 580 | 534 |
| 90 | wt. % | 1143 | 749 | 673 |
| 95 | wt. % | 1152 | 815 | 744 |
| 99.5 | wt. % | 1226 | 981 | 920 |

As shown in Table 1, the liquid products from Runs 1-2 had significantly reduced TAN and chloride and residual metals content compared to the UCO feed.

Elemental analysis shows that the oxygen content in the liquid products from Runs 1-2 is lower than what a ketonization reaction alone would be expected to yield. Moreover, SIMDIS shows that >95% of the liquid products from Runs 1-2 are lower boiling than ketone dimers would be expected to have and at least 60% of the liquid products from Runs 1-2 are lighter than would be expected for a fatty acid unit alone. While not being bound by theory, it is believed that the observed liquid product distribution is not consistent with the composition undergoing a ketonization process exclusively and may be more consistent with a combined ketonization and pyrolysis process (i.e., a “ketopyrolysis” process).

### The Reactor System

As described above, in order to provide renewable feedstocks of bio-oils suitable for refinery operations, the lipid feedstock is treated with a metal oxide catalyst to produce a treated stream. The treated stream can be condensed and fractionated into a gas fraction and a liquid fraction, wherein the liquid fraction comprises water and a bio-oil suitable for use as a renewable feedstock for hydroprocessing. Example reactor systems for treating lipid feedstocks will now be described in greater detail.

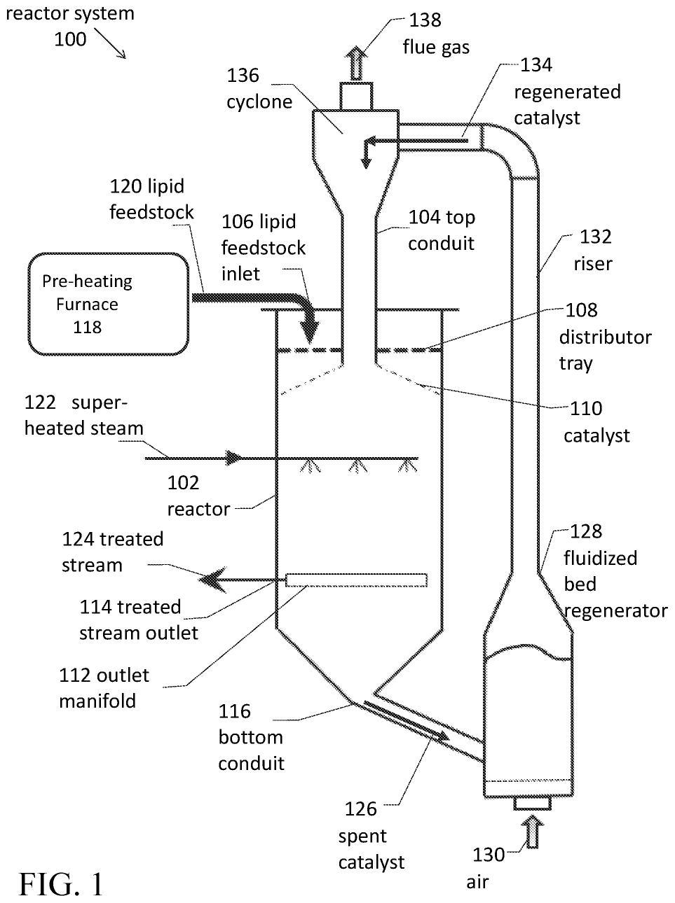

FIG. 1 illustrates one example reactor system in accordance with embodiments of the present disclosure. It should be understood that the example embodiments described herein can be applied to other types of reactor systems as well.

FIG. 1 illustrates certain components associated with a reactor system 100. Reactor system 100 can be used to treat a lipid feedstock and produce a bio-oil renewable feedstock that is suitable for processing in a refinery for the ultimate production of transportation fuels. The reactor system 100 comprises a reactor 102 that is a concurrent downflow moving bed reactor and that is fluidly coupled to a fluidized bed regenerator 128. A moving bed reactor can be advantageous in that it reduces the likelihood of clogging of the components within the reactor. The reactor bottom is coupled to a bottom of the fluidized bed regenerator 128 by a bottom conduit 116. The fluidized bed regenerator 128 has a top that is coupled to a riser 132, such as a pneumatic transport riser. A top conduit 104 connects a bottom of a cyclone 136 to a top of the reactor 102.

Further details will now be described in connection with the operation of the reactor system 100. A lipid feedstock 120 is directed into the moving bed reactor 102 at a lipid feedstock inlet 106. Optionally, the lipid feedstock 120 can be heated in a pre-heating furnace 118 before entering the moving bed reactor 102. In one example as illustrated in FIG. 1, the lipid feedstock inlet 106 can be located at the top of the moving bed reactor 102 and a distributor tray 108 is used to accomplish uniform distribution and even mixing by spraying the lipid feedstock 120 onto the metal oxide catalyst 110 within the reactor. Alternatively, the lipid feedstock inlet can be located in the top conduit 104 so that the lipid feedstock is mixed with the metal oxide catalyst before the metal oxide catalyst enters the moving bed reactor 102.

The lipid feedstock 120 typically is mixed with a steam stream prior to entering the reactor 102 through the lipid feedstock inlet 106. As representative examples, the lipid feedstock comprises a 50 wt. % vapor and 50 wt, % liquid mixture that flows into the moving bed reactor 102 at a rate of 10,000 bpd (60,750 kg/h), while the steam stream flows into the moving bed reactor 102 at a rate of 30,375 kg/h. The resulting lipid steam mixture flowing into the moving bed reactor is in a ratio of steam wt. % to lipid wt. % of 0.5 to 1 with a feed temperature of 485° C. and a pressure of 100 psig. The foregoing values for the feed rates, relative proportions, temperature, and pressure are simply representative examples and alternate embodiments encompass ranges of plus or minus 50% of these values.

The moving bed reactor 102 is typically generally cylindrical in shape and can have various dimensions. The representative example of a cylindrical reactor 102 in FIG. 1 can have an inner diameter of 2.6 meters in width, a height of 12.5 meters, a volume of 66 cubic meters, and differential pressure between the top and bottom of the reactor of 50 psi. As a concurrent downflow moving bed reactor 102, the lipid feedstock (mixed with steam) and the metal oxide catalyst 110 flow in a downward direction toward the bottom of the reactor as they are mixed and react under the treating conditions within the reactor 102. Representative ranges for the treating conditions within the reactor 102 are: a temperature in the range of 400° C. to 700° C., a pressure in the range of 0 to 10 MPa, and a liquid hourly space velocity in a range of 0.1 to 10 h⁻¹. The metal oxide catalyst typically will move at a slower velocity than the lipid feedstock in a downward direction through the reactor with a typical metal oxide catalyst residence time of 5.25 hours within the reactor 102, however, in other example embodiments the metal oxide catalyst residence time can range from 10 minutes to 24 hours. When referencing the metal oxide catalyst 110 in connection with the moving bed reactor 102 of FIG. 1, it should be understood that includes an oxide support. Examples of metal oxides and the oxide support for the catalyst were provided above in the description of the treatment of the lipid feedstock. The metal oxide catalyst within the reactor typically has a packed density in the range of 400 to 1000 kg/m³. The catalyst particles are typically spherical or spheroid in shape having a diameter ranging from 1-3 mm.

The example reactor system 100 of FIG. 1 includes an optional stream of super-heated steam or a quench stream 122 that can facilitate controlling the temperature profile during the treatment of the lipid feedstock 120 within the reactor. As the mixture of the lipid feedstock 120 and the metal oxide catalyst 110 move downward through the reactor, the lipid feedstock 120 is treated resulting in a treated stream 124 that is gathered at outlet manifold 112 and that exits the reactor at treated stream outlet 114. As provided above in the description of the lipid feedstock treatment, the reaction with the metal oxide catalyst results in a treated stream that has a lower content of oxygen and impurities relative to the lipid feedstock 120 that entered the reactor 102 and a TAN of <5 mg KOH/g. As representative values, the treated stream 124 can exit the moving bed reactor 102 at a pressure of about 50 psig and a temperature of about 485° C.

As the metal oxide catalyst 110 continues moving towards the bottom of the moving bed reactor 102 it can be referred to as spent metal oxide catalyst because it becomes coated with coke and mixed with particles of impurities, such as metal impurities, phosphorus, and chloride, that were present in the lipid feedstock 120. An advantage of the continuous movement of the two streams within the moving bed reactor is that the presence of coke and impurities is less likely to clog the reactor. The spent metal oxide catalyst 126 is directed out of a spent catalyst outlet at the bottom of the moving bed reactor 102 and proceeds through bottom conduit 116 to the fluidized bed regenerator 128. A representative temperature for the spent metal oxide catalyst 126 exiting the moving bed reactor 102 is about 485° C.

The fluidized bed regenerator 128 is typically cylindrical in shape but smaller in scale than the moving bed reactor 102. As one example, the inner diameter of the fluidized bed reactor can be about 0.84 m. The fluidized bed regenerator 128 includes an air inlet through which a flow of air 130 enters for combustion within the regenerator. As one example, the air flow 130 can be at a rate of about 365 m³/hr. As the spent metal oxide catalyst flows through the fluidized bed regenerator 128 it undergoes combustion. As one example, the metal oxide catalyst can flow through the fluidized bed regenerator 128 at a circulation rate of 7,000 kg/h. Combustion within the fluidized bed regenerator 128 burns the coke off the catalyst returning the spent metal oxide catalyst to a metal oxide catalyst that can be used again in the moving bed reactor 102. In certain example embodiments, fuel can be added to the air flow 130 to increase the combustion within the fluidized bed regenerator 128 and add heat to the metal oxide catalyst.

The metal oxide catalyst that has been regenerated flows upward through a riser 132 attached to the top of the fluidized bed regenerator 128. The riser 132 can be a pneumatic transport riser having a diameter, for example, of 8 inches. At the top of the riser 132, a cyclone 136 can separate the metal oxide catalyst from the flue gas and direct the flue gas out of the reactor system 100 through a flue gas outlet. The motion of the fluidized bed regenerator also assists in separating particles of impurities from the regenerated metal oxide catalyst. The cyclone 136 can direct the particles of impurities out of the reactor system 100 through the flue gas outlet as well.

The metal oxide catalyst that has been regenerated in the fluidized bed regenerator flows from the riser 132, through the cyclone 136, and through the top conduit 104 where it reenters the top of the moving bed reactor 102 via a metal oxide catalyst inlet. The metal oxide catalyst 110 then continues the treatment of new lipid feedstock that enters the reactor 102 as both flow in a downward direction. It can be beneficial to the treatment conditions within the reactor 102 if the lipid feedstock 120 enters the reactor 102 at a temperature that is below a reaction temperature. In order to raise the temperature of the lipid feedstock 120 within the reactor, the metal oxide catalyst 110 that is returned to the reactor 102 from the fluidized bed regenerator 128 can contribute heat to the lipid feedstock 120. As one example, the lipid feedstock 120 can enter the moving bed reactor 102 at a temperature of about 485° C. and the metal oxide catalyst 110 from the fluidized bed regenerator 128 can enter the moving bed reactor 102 at a temperature of about 650° C. Thus, the metal oxide catalyst 110 can raise the temperature of the lipid feedstock 120 closer to a reaction temperature or to a reaction temperature within the moving bed reactor 102. If needed, the temperature of the metal oxide catalyst can be increased when it is in the fluidized bed regenerator 128 by adding fuel to the air flow 130 entering the fluidized bed regenerator 128.

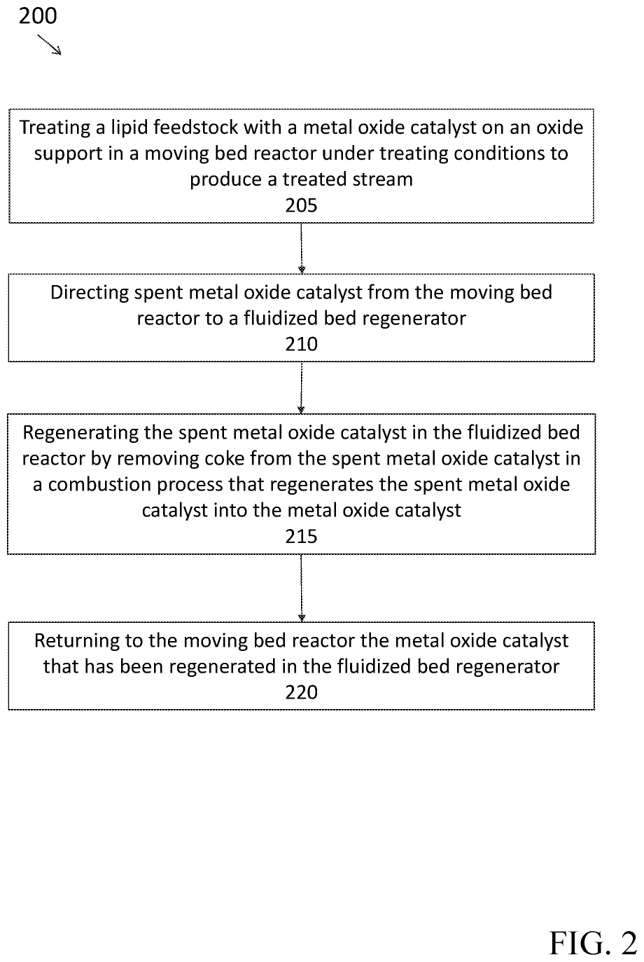

Referring now to FIG. 2, an example process 200 for operation of a reactor system is illustrated. The operations of example process 200 can correspond to the example reactor system 100 of FIG. 1 or to a different example reactor system within the scope of this disclosure. The operations of example process 200 are simply examples and in other embodiments the operations of process 200 can be modified.

Referring to operation 205 of process 200, a lipid feedstock is treated with a metal oxide catalyst (which includes an oxide support) with a moving bed reactor. Treating conditions within the moving bed reactor, such as those treating conditions described previously, produce a treated stream. The treated stream can be removed from the moving bed reactor and condensed to obtain a bio-oil renewable feedstock that is suitable for refining into a transportation fuel.

In certain embodiments, the treated stream can comprise a “heavy ends” product having a boiling point greater than 360° C., which is too high to be used as a transportation fuel. This heavy ends product of the treated stream can be used: a) in the production of renewable base oil for lubricants applications, b) in a hydrocracker where it is processed into a product with a boiling temperature in the transportation fuel range, or c) it can be recycled and returned with the lipid feedstock to the moving bed reactor where it will be thermally cracked into additional fuel range products.

In operation 210, spent metal oxide catalyst resulting from the treating of the lipid feedstock is directed from the moving bed reactor to a fluidized bed regenerator. The spent metal oxide catalyst may contain coke deposits from the treating process and may be mixed with particles of impurities that were present in the lipid feedstock. A moving bed reactor minimizes the likelihood that the coke deposits and the particles of impurities will cause clogging of the reactor.

In operation 215, the spent metal oxide catalyst is regenerated by a combustion process in the fluidized bed regenerator that burns the coke off the catalyst. Air and fuel can be introduced into the fluidized bed regenerator to enhance the combustion process and increase the heat of the metal oxide catalyst. The motion within the fluidized bed regenerator also can assist with separating particles of impurities from the metal oxide catalyst.

In operation 220, metal oxide catalyst resulting from the regenerating process in the fluidized bed regenerator is returned to the moving bed reactor where it can be used again to treat additional lipid feedstock. Heating of the metal oxide catalyst from the combustion process in the fluidized bed regenerator can contribute beneficial heat to the lipid feedstock when the two are mixed in the moving bed reactor.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation unless so indicated by the context, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a”, “an”, and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A process comprising:
treating a lipid feedstock comprising at least one fatty acid in a moving bed reactor with a metal oxide catalyst on an oxide support under treating conditions to produce a treated stream, wherein the treating conditions in the moving bed reactor include a temperature in a range of from 400° C. to 700° C., a pressure in a range from 0 to 10 MPa, and a liquid hourly space velocity in a range from 0.1 to 10 h⁻¹;
directing spent metal oxide catalyst from the moving bed reactor to a fluidized bed regenerator, the spent metal oxide catalyst resulting from treating the lipid feedstock with the metal oxide catalyst;
regenerating the spent metal oxide catalyst in the fluidized bed regenerator by removing coke from the spent metal oxide catalyst in a combustion process that regenerates the spent metal oxide catalyst into the metal oxide catalyst; and
returning to the moving bed reactor the metal oxide catalyst that has been regenerated in the fluidized bed regenerator.

2. The process of claim 1, wherein the moving bed reactor is a concurrent downflow reactor in which the lipid feedstock and the metal oxide catalyst flow from a top of the moving bed reactor to a bottom of the moving bed reactor.

3. The process of claim 2, wherein the combustion process in the fluidized bed regenerator adds heat to the metal oxide catalyst that is returned to the moving bed reactor.

4. The process of claim 3, wherein the lipid feedstock is at a temperature that is below a reaction temperature when mixed with the metal oxide catalyst and wherein the metal oxide catalyst that is returned to the moving bed reactor from the fluidized bed regenerator raises the temperature of the lipid feedstock.

5. The process of claim 1, wherein the lipid feedstock is converted to a gaseous stream when mixed with the metal oxide catalyst.

6. The process of claim 1, further comprising distributing the lipid feedstock over the metal oxide catalyst with a distributor tray located within the moving bed reactor.

7. The process of claim 1, further comprising mixing the lipid feedstock with the metal oxide catalyst in a top conduit before the metal oxide catalyst enters a top of the moving bed reactor.

8. The process of claim 1, further comprising mixing superheated steam or a quench stream with the metal oxide catalyst and the lipid feedstock within the moving bed reactor.

9. The process of claim 1, further comprising preheating the lipid feedstock to a temperature that is below a reaction temperature prior to directing the lipid feedstock into the moving bed reactor.

10. The process of claim 1, further comprising fractionating the treated stream after it leaves the moving bed reactor to obtain a gaseous fraction and a liquid fraction, wherein the liquid fraction comprises a bio-oil having a lower oxygen content when compared to the lipid feedstock.

11. A reactor system comprising:
a lipid feedstock inlet that directs a lipid feedstock into the reactor system;
a moving bed reactor comprising metal oxide catalyst, a metal oxide catalyst inlet, a treated stream outlet, and a spent catalyst outlet;
a fluidize bed regenerator comprising an air inlet, a riser, and a flue gas outlet;
a bottom conduit connecting the spent catalyst outlet to the fluidized bed regenerator; and
a top conduit connecting the metal oxide catalyst inlet to the riser.

12. The reactor system of claim 11, wherein the lipid feedstock is treated in the moving bed reactor under treating conditions to produce a treated stream at the treated stream outlet, wherein the treating conditions in the moving bed reactor include a temperature in a range of from 400 degrees C. to 700 degrees C., a pressure in a range from 0 to 10 MPa, and a liquid hourly space velocity in a range from 0.1 to 10 h⁻¹.

13. The reactor system of claim 12, wherein spent metal oxide catalyst resulting from treating the lipid feedstock with the metal oxide catalyst is directed out the spent catalyst outlet and through the bottom conduit to the fluidized bed regenerator.

14. The reactor system of claim 13, wherein a combustion process in the fluidized bed regenerator removes coke from the spent metal oxide catalyst thereby regenerating the spent metal oxide catalyst into metal oxide catalyst.

15. The reactor system of claim 14, wherein the metal oxide catalyst regenerated in the fluidized bed regenerator is directed through the riser, through the top conduit, through the metal oxide catalyst inlet, and into the moving bed reactor.

16. The reactor system of claim 11, further comprising a distributor tray, wherein the lipid feedstock inlet is located at the top of the moving bed reactor and the distributor tray distributes the lipid feedstock onto the metal oxide catalyst within the moving bed reactor.

17. The reactor system of claim 11, wherein the lipid feedstock inlet is located in the top conduit and the lipid feedstock is mixed with the metal oxide catalyst before the metal oxide catalyst enters the moving bed reactor.

18. The reactor system of claim 12, further comprising an outlet manifold that directs the treated stream out of the moving bed reactor at the treated stream outlet, wherein the treated stream comprises a gaseous fraction and a liquid fraction, wherein the liquid fraction comprises a bio-oil having a lower oxygen content when compared to the lipid feedstock.

19. The reactor system of claim 15, wherein the lipid feedstock is at a temperature that is below a reaction temperature when mixed with the metal oxide catalyst and wherein the metal oxide catalyst that is returned to the moving bed reactor from the fluidized bed regenerator raises the temperature of the lipid feedstock.

20. The reactor system of claim 12, further comprising a pre-heating furnace that preheats the lipid feedstock to a temperature that is below a reaction temperature prior to directing the lipid feedstock into the moving bed reactor.
